(19) United States
(12) Patent Application Publication
(10) Pub. No.: US 2022/0282036 A1
(43) Pub. Date: Sep. 8, 2022

(54) A PROCESS FOR MANUFACTURING SPECIALTY POLYESTERS & CO-POLYESTERS FROM RECYCLED BIS 2-HYDROXYETHYL TEREPHTHALATE (rBHET) AND PRODUCT THEREOF

(71) Applicant: Sanjay Tammaji KULKARNI, Pune, Maharashtra (IN)

(72) Inventor: Sanjay Tammaji KULKARNI, Pune, Maharashtra (IN)

(21) Appl. No.: 17/637,919

(22) PCT Filed: Aug. 28, 2020
(86) PCT No.: PCT/IB2020/058051

§ 371 Date: Feb. 24, 2022

(30) Foreign Application Priority Data
Aug. 28, 2019 (IN) 201921034708

(51) Int. Cl. C08G 63/91; C08G 63/86

(52) U.S. Cl. CPC C08G 63/916; C08G 63/866; C08G 2120/00; C08G 2250/00

(57) ABSTRACT

The present invention relates to the process for manufacturing specialty polyesters & copolyesters from recycled Bis 2-Hydroxyethyl terephthalate (rBHET) derived from Polyethylene terephthalate (PET) recycled from PET scraps or waste. The polyesters/co-polyesters thus obtained are clean and of high quality which can be used for all applications but not limited to textiles, packaging, engineering and industry.

### FIELD OF THE INVENTION

The present invention relates to a process of recycling Polyethylene terephthalate (PET). More particularly, the present invention relates to a process for manufacturing eco-friendly specialty polyesters and co-polyesters from recycled Bis 2-Hydroxyethyl terephthalate (r BHET) derived from Polyethylene terephthalate (PET) recycled from PET scraps or waste.

### BACKGROUND OF THE INVENTION

Polyethylene terephthalate (PET) is a member of polyester family of thermoplastic polymers having wide applications in engineering, textiles and packaging (both rigid & flexible packaging). PET is a highly flexible, colourless and semi-crystalline resin in its natural state. The rigidity of PET depends upon its processing. The polymer is processed by extrusion & spinning, molding (injection stretch blow molding, extrusion blow molding, injection blow molding, etc.), coating and lamination etc. to manufacture various articles such as fibres, filament yarns for apparels and industrial applications, nonwovens, carpets, containers, films and sheets etc.

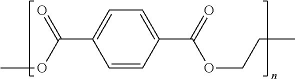

PET is obtained by polymerization of ethylene glycol and terephthalic acid (PTA) in the presence of catalysts.

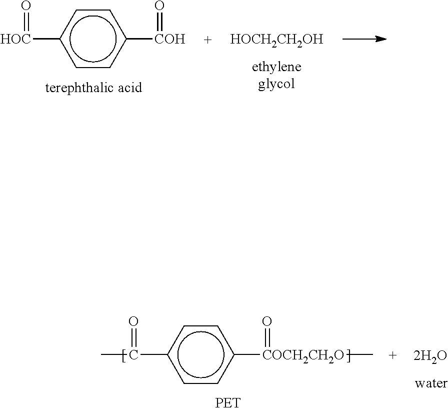

The current conventional means for manufacture of PET polyesters and other similar polyesters such as polybutylene terephthalate (PBT), polytrimethylene terephthalate (PTT) and various co-polyesters is to use purified terephthalic acid or derivatives thereof and diols as a primary feed stock. The derivatives of terephthalic acid include but are not limited to Dimethyl terephthalate (DMT) etc. PTA is the preferred feedstock. The diols used herein include but are not limited to Mono Ethylene Glycol (MEG); 1,4 Butanediol (BDO) and 1,3-Propanediol (PDO) etc.

The reaction of a PTA or derivatives thereof with diols is a two-step reaction, esterification followed by polycondensation. In esterification, first the diacid such as purified terephthalic acid (PTA) is reacted with diol such as Mono Ethylene Glycol (MEG)/1,4 Butanediol (BDO)/1,3 Propanediol (PDO) to get monomer/pre-polymer such as bis-hydroxy ethylene terephthalate (BHET)/bis (4-hydroxybutyl) terephthalate (BHBT)/bis-(2-hydroxypropyl terephthalate) (BHPT) with by-product release as water.

In polycondensation, the monomer/pre-polymer thus obtained is then reacted under polymerization reaction to get polymers including but not limited to polyethylene terephthalate (PET), polybutylene terephthalate (PBT), polytrimethylene terephthalate (PTT) with by-product release as relevant diol such as Mono Ethylene Glycol (MEG), 1,4 Butanediol (BDO), 1,3 Propanediol (PDO) respectively.

PET being poorly biodegradable, removal of its waste is difficult. The waste PET can be removed either by burning or by recycling. As burning will cause health risk and pollution to the environment due to release to toxic fumes in the atmosphere. Therefore, as an acceptable solution, the recycling of PET is much more advantageous.

Now a days, recycling PET has become important for protecting environment and to achieve sustainability. Hence, waste PET in the form of fabric/yarn/containers/films/polymer lumps etc. has become an important source for recycling. Both chemical recycling and mechanical recycling processes have been developed. Through mechanical recycling it is difficult to get clean product as the waste PET collected has lot of polymeric and non-polymeric contamination which makes it difficult to obtain resultant recycled Polyethylene terephthalate (PET). Further, processing of recycled Polyethylene terephthalate (PET) is difficult because of residual presence of contaminations. The chemical recycling process by glycolysis also can not completely remove presence of polymeric & non-polymeric contaminants. The other chemical recycling processes such as methanolysis (to obtain DMT) & Hydrolysis (to obtain PTA) are quite expensive.

Bis 2-Hydroxyethyl terephthalate (BHET) is a product obtained from glycolysis of PET waste and is further purified by various techniques such as fermentation, multistage-purification steps, using microwave techniques, Ionic liquids etc. BHET can be further used to obtain recycled PET by polycondensation process wherein Mono Ethylene Glycol (MEG) is a by-product.

Till date, pure & clean Bis 2-Hydroxyethyl terephthalate (BHET) was not commercially available. But now, it is available as many companies have developed purification processes to remove colour, residual catalysts, polymeric contamination (particularly used in multilayer bottles, sheets, films, conjugate fibres, carpets etc.) and various co-monomers used. However, none of the existing PET recycling processes including mechanical recycling, Chemical recycling (methanolysis, glycolysis, Hydrolysis) purification processes is known to yield high quality recycled products (polyesters) which are as pure as the initially synthesized products made from virgin raw materials.

Therefore, the problem with the existing processes is that the earlier technologies or methods are not capable of yielding clean product and are not economically significant.

Accordingly, instead of using virgin raw materials viz. PTA & MEG, or RPET waste as such or using existing chemical recycling processes with RPET as starting material, use of rBHET as starting material, which is a monomer available in molten form or in the form of powder is advantageous in many aspects. This can be used as a raw material to manufacture rPET Polyester. Also, by charging other diols with BHET, the MEG molecule in BHET can be replaced with other diols such as 1,4 Butanediol (BDO) or 1,3-Propanediol PDO and from rBHET, recycled polybutylene terephthalate (PBT) or recycled polytrimethylene terephthalate (PTT) can be manufactured.

By adding various co-monomers & additives, specialty grade polymers, copolymers or blended polymers can be manufactured with modified properties required/desired for various applications.

### OBJECTIVES OF THE INVENTION

To solve the prevailing difficulties in existing recycling processes and to obtain high quality rPET, an object of the present invention is to manufacture high quality, clean polyesters/co-polyesters from BHET derived from PET waste which can be used for various applications not limited to textiles, packaging, engineering and industry.

Another objective of the present invention is to purify BHET from recycled BHET obtained from chemical recycling of PET.

Yet another objective of the present invention is to manufacture high quality chemically recycled PET polyesters from recycled BHET.

Yet another objective of the present invention is to manufacture specialty chemically recycled PET by adding various additives/co-monomers in recycled BHET such as different alkylene/aromatic diols, aliphatic/aromatic diacids or esters thereof; poly alkylene diols (such as Polyethylene Glycols, Poly propylene Glycols etc.); esters of various diacids & diols; co-monomers such as DMSIP/SIPA etc.; or esters thereof in order to improve specific performance/properties as required in various applications.

Still another objective of the invention is to increase the dyeability, flame retardancy and stain resistance of the existing polymers by blending the recycled PET to form the blended polyesters/co-polyesters.

Another objective of the present invention is to manufacture pure products for packaging applications at competitive costs.

Another objective of the present invention is to reduce investment and convertion costs.

Another objective of the present invention is to enable convenient use of many comonomers.

Yet another objective of the present invention is to manufacture master batches with various functionalities.

Yet another objective of the present invention is to manufacture Green PBT, Green PTT & other Green co-polyesters.

Yet another objective of the present invention is to manufacture flame retardant (FR) Polyesters & co-polyesters.

### DESCRIPTION OF THE INVENTION

It should be noted that the particular description and embodiments set forth in the specification below are merely exemplary of the wide variety and arrangement of reactions which can be employed in the present invention. The present invention may be embodied in other specific forms without departing from the spirit or essential characteristics thereof. Thus, unless expressly stated otherwise, all embodiments are within the scope of the present invention. Various modifications or substitutions are also possible without departing from the scope or spirit of the present invention. Therefore, it is to be understood that this specification has been described by way of the most preferred embodiments and for the purposes of illustration and not limitation.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The term “degree of polymerization” (DP) herein refers to number of monomer units in a polymer.

The present invention discloses a process of purification of BHET obtained from chemical recycling of PET polyester scrap. After glycolysis (chemical recycling), the Bis 2-Hydroxyethyl terephthalate (BHET) is subjected to various purification processes to obtain clean rBHET.

The clean BHET is thereafter used as starting material instead of PTA and MEG to manufacture Polyesters. BHET is a monomer and available in molten or powdered form. It can be used as a raw material to manufacture PET Polyester.

The recycled BHET is available in molten form or in powder form. The melting point of recycled BHET is around 110° C. The recycled BHET is charged to the reactor equipped with heating coils and agitator. The temperature of reactor is gradually increased to a temperature upto 300° C. under stirring and a high pressure is applied for a particular time. Requisite quantity of catalyst and/or additive is added in the form of solution in a glycol. Then gradually reactor pressure is reduced upto 0.1 millibar pressure while product temperature is gradually increased to about 280° C. Polycondensation reaction occurs with the glycol as a by-product which is distilled out.

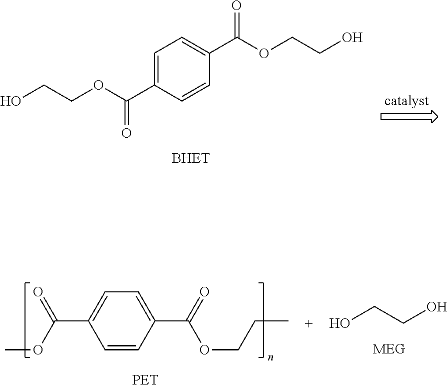

After achieving requisite degree of polymerization which is monitored based on agitator motor power consumption, the reaction is terminated, and the polymer is extruded using underwater granulator or any other type of granulator/Pelletizer.

The degree of polymerization is ascertained in the laboratory using Intrinsic viscosity (I.V.) by solution viscosity measurement and also other chemical properties and rheological properties are checked so as to adjust the process for optimum properties.

The co-polyester may be further subjected to solid state polymerization (SSP). The SSP leads to an increase in the molecular weight and/or intrinsic viscosity of the co-polyester product and reduction in oligomer contents. If required, the polymer granules are crystallized and further upgraded to required I.V. by Solid State Polymerization (SSP) in batch reactor or continuous reactor. Finally, product in granular form is packed.

Optional additives used to manufacture specialty polyesters include:
a) Aromatic sulfonated salts in an amount of 2 weight % to 50 weight % Na, wherein the metal can be Li, Na, K, Mg, Ni, Ca and Fe in required form such as SIPA/DMSIP Dimethyl-5-Sulfoisophthalate Sodium Salt) or the Esters thereof.
b) Other alkaline dicarboxylic acids/esters thereof such as adipic acid, sebacic acid, NDA (Naphthene dicarboxylic acid) etc & aromatic diacids;
c) Alkylene & aromatic diols;
d) Isosorbide, polyalkylene Glycols;
e) Other Polyesters such as PBT, PTT & Co-polyesters;
f) Reactive Phosphorus based additives, compatibilizers, antioxidants, nucleating agents.
g) Chain extenders, heat stabilizers, antioxidants, branching agent's specialty master batches of functional additives.

In an embodiment of the present invention, the additives:
Isosorbides, Polyalkylene glycols such as Poly Ethylene Glycols (PEG) of molecular weights up to 10000 and Poly Propylene Glycols;
heat stabilizers and antioxidants incorporated in polymerization process up to 8000 ppm.
   branching agents/chain extenders added up to 8000 ppm.
nucleating agents added up to 2000 ppm;
fast crystallizing Polyesters such as PBT & PTT are incorporated up to 20 weight %;
other aliphatic and aromatic dicarboxyllic acids or esters of these acids such as succinic acid, adipic acid, isophthalic acid, Naphthalene dicarboxylic acid incorporated to the extent 20%; and
aromatic metal sulfonated salt of 2 weight % to 50 weight %.

The comonomers are selected from the group of aliphatic and aromatic diacids selected from dicarboxylic acids/including but not limited to acids/esters of succinic acid, adipic acid, isophthalic acid, sebacic acid, IPA, NDC, Naphthoic acid NDA (Naph-thene dicarboxylic acid), hydroxyphenylphosphinyl propanoic acid (UKANOL FR 50) and aromatic diacid.

The polyalkylene glycols may be selected from but not limited to glycols such as Poly Ethylene Glycols (PEG) of molecular weights up to 10000 and Poly Propylene Glycols.

The heat stabilizers and antioxidants may be incorporated in polymerization process up to 8000 ppm. The anti-oxidizing agents may be selected from, but are not limited to, Irganox® 1010, Irganox® 1076, Irgafos® 126 and Irgafos® 168. The heat stabilizers are selected from but not limited to flame retardants such as decabromodiphenyl ether and triarylphosphates, such as triphenylphosphate.

The catalysts may be selected from oxides/acetates of antimony (Sb), Titanium(Ti), Germanium(Ge), Manganese(Mn), Cobalt(Co), Tin(Sn), Ca(Calcium) and are used up to 800 ppm of the element. The catalyst used herein is a compound containing a metal selected from but not limited to antimony (Sb), titanium (Ti) and germanium (Ge). The metal compound is selected form the compounds including but not limited to antimony trioxide/antimony triacetate, Tetra isopropyl titanate, tetra butyl titanate, Potassium Titanium oxalate, Germanium Dioxide and a mixture thereof.

The branching agents/chain extenders may be optionally added added up to 8000 ppm. The branching agents may be selected from, but not limited to, 1,2,4-benzenetricarboxylic acid (trimellitic acid); trimethyl-1,2,4-benzenetricarboxylate; 1,2,4-benzenetricarboxylic anhydride (trimellitic anhydride); 1,3,5-benzenetricarboxylic acid; 1,2,4,5-benzenetetracarboxylic acid (pyromellitic acid); 1,2,4,5-benzenetetracarboxylic dianhydride (pyromellitic anhydride); 3,3′,4,4′-benzophenonetetracarboxylic dianhydride; 1,4,5,8-naphthalenetetracarboxylic dianhydride; citric acid; tetrahydrofuran-2,3,4,5-tetracarboxylic acid; 1,3,5-cyclohexanetricarboxylic acid; pentaerythritol, 2-(hydroxymethyl)-1,3-propanediol; 2,2-bis(hydroxymethyl) propionic acid; sorbitol; glycerol; or a combination of any two or more thereof. Particularly, branching agents may include pentaerythritol, trimellitic acid, trimellitic anhydride, pyromellitic acid, pyromellitic anhydride and sorbitol.

The nucleating agents may be optionally added up to 2000 ppm. The nucleating agent may be organic or inorganic. Examples of inorganic nucleating agent include, but are not limited to, calcium silicate, nano silica powder, talc, microtalc, aclyn, kaolinite, montmorillonite, synthetic mica, calcium sulfide, boron nitride, barium sulfate, aluminum oxide, neodymium oxide, or a metal salt of phenyl phosphonate. The inorganic nucleating agent can be modified by an organic material to improve its dispersibility in the polyester product of the present disclosure. Examples of organic nucleating agent include, but are not limited to, carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, potassium dibenzoate, lithium dibenzoate, sodium β-naphthalate and sodium cyclohexane carboxylate; organic sulfonates such as sodium p-toluene sulfonate and sodium sulfoisophthalate; carboxylic acid amides such as stearic acid amide, ethylene bis-lauric acid amide, palmitic acid amide, hydroxystearic acid amide, erucic acid amide and tris(t-butylamide) trimesate; phosphoric compound metal salts such as benzylidene sorbitol and derivatives thereof, sodium-2,2′-methylenebis(4,6-di-t-butylphenyl)phosphate, and 2,2-methylbis (4,6-di-t-butylphenyl)sodium, and the like, or a combination of any two or more thereof.

Fast crystallizing Polyesters such as polybutylene terephthalate (PBT), polypropylene terephthalate (PTT), polybutylene naphthalate (PBN), fast crystallizing polyester, polypropylene naphthalate (PTN) or a combination thereof may be optionally incorporated up to 20 weight % by weight of the total weight of the co-polyester composition.

Aliphatic & aromatic dicarboxylic acids or esters of acids such as succinic acid, adipic acid, isophthalic acid, Naphthalene dicarboxylic acid may also be incorporated upto the extent 20 wt %.

The recycled product has the following significant features:
Melt flow rate of 5 to 60 g/10 min at 270 degrees Celsius under 2.16 kg weight
Intrinsic viscosity more than 0.250 dl/g & up to 1.60 dl/g
Sulfonated salt content up to 50 weight % i.e. S content upto 50000 ppm
P content up to 60000 ppm

Also, by charging other diols with BHET, various products can be obtained. For instance, the MEG (Mono ethylene glycol) molecule in BHET can be replaced with other diols such as 1,4 Butanediol (BDO) or 1,3-Propanediol (PDO) hexanediol, cyclohexanedi methanol etc., and from BHET, specialty grade polyesters such as polybutylene terephthalate (PBT), or polytrimethylene terephthalate (PTT) etc. can be manufactured.

The diol may also include suitable diols known in the art. For example, the alkylene diol may include glycols that have 2 to 20 carbon atoms. The diols may be un-substituted or substituted; straight chain, branched, cyclic aliphatic diol, aliphatic-aromatic diol, aromatic diol, or a combination of any two or more thereof. The diol can also be poly (alkylene ether) glycols with molecular weights between about 250 to about 4,000. Examples of dihydric alcohols include ethylene glycol, 1,3-propanediol, 1,4-butanediol, 1,6-hexanediol, and poly (ethylene ether) glycols. The branched diols include C₄-C₁₆ aliphatic branched diols. The branched diol may have 4-12 carbon atoms. In some embodiments, the branched diol may have 4-10 carbon atoms. In other embodiments, the branched diol may have 4-8 carbon atoms.

Further, by adding various co-monomers & additives, specialty polyesters can be manufactured with modified properties required/desired for various applications. The additives may be selected from Isosorbides, Polyalkylene glycols, heat stabilizers, antioxidants, catalysts, branching agents/chain extenders, nucleating agents, crystallizing Polyesters, aliphatic or aromatic dicarboxylic acids or esters etc.

Further, the above co-polyester and/or co-polyester blend may be used with other polyesters, nylon, polyethylene and polypropylene polymers in textile applications to achieve easier and superior dyeability with cationic & disperse dyes than non-blended polymers. For instance, the copolyesters and/or co-polyester blended with Polyesters and & nylons show flame retardancy property (FR Property). The FR property is permanent due to reacted P molecules and do not reduce due to washing. Also, the co-Polyester manufactured according to the present invention blend with nylons to have permanent stain resistance property.

The recycled product thus produced can be used in textiles, packaging and engineering applications

### Purification of Recycled BHET

Recycled BHET (rBHET) is manufactured from recycled Polyester scrap which is manufactured by glycolysis of polyester scrap. The Polyester scrap is heated with monoethylene glycol (MEG) at about 200 to 240 degree celcius temperature under stirring under nitrogen pressure of 2.5 bar. After complete depolymerization in presence of MEG, the rBHET is purified by multistage purification process so as to get pure BHET free from any polymeric and nonpolymeric impurities. The rBHET is available in molten form or in powder form. As already BHET is a monomer there is no need of esterification reaction.

BHET is purified by employing the following steps known to a person skilled in the art:
Multistage purification methods
Using microwave reactors
Using Ionic fluids
Using special filtration & crystallization techniques
Using fermentation techniques

### Preparation of Polyesters from Recycled BHET

I. Heating recycled BHET powder in a reactor by increasing temperature to 120 degree Celsius under stirring to melt rBHET;
II. Preparing a mixture of catalyst and diol.
III. adding the mixture of step II and at least one co-monomer and additive to the melted rBHET powder of step I;
IV. increasing temperature of the mixture of step III gradually in a range of 120-240;
V. Adding diols and/or comonomers to the mixture of step IV and applying a pressure of 2.5 bar-3.5 bar absolute to the mixture for a time period in the range 30-40 minutes followed by Depressurizing the reactor in 10 minutes and evacuating the reactor gradually to a pressure of 100 mb in 30 minutes to distill the byproduct;
VI. Increasing temperature of the product to 290° C. and reducing the reactor pressure to 0.20 mb-0.1 mb to obtain polymerized product having degree of polymerization (DP) >50;
VII. Terminating the reaction and granulating the polymer;
VIII. optionally upgrading the granules by solid state polymerization (SSP) process at a temperature in the range of 160 to 220° C. under vacuum in batch reactor or in continuous
SSP process operating under nitrogen purge; IX. cooling and packing the polyester or co-polyester obtained as the final product.

Step I: BHET Powder obtained from the waste polyester scraps is recycled in reactors equipped with heating coils and agitator. A heat transfer oil is circulated in the heating coils. The temperature of rBHET is gradually increased above it's melting point which is 110 degree celcius. The required catalyst solution and additive is added to the reactants. Product temperature is increased gradually to 240 degree Celsius. Thereafter, the required diols and/or co-monomers are added and reactor is pressurized with Nitrogen to a pressure of 2.5 bar absolute. After 30 minutes the reactor is depressurized in 10 minutes and evacuated gradually to a pressure of 100 mb in 30 minutes. The methyl ethylene (MEG)/diol byproduct is distilled. Once the byproduct distillation is completed, gradual heating is continued to increase product temperature to 290 degree Celsius and reactor pressure is gradually reduced to 0.20 mb and polymerization is continued. After achieving required degree of polymerization (DP) of >50, the reaction is terminated and polymer is granulated. The resultant granules can be further upgraded in solid state polymerization (SSP) process at temperature 160 to 220 degree celcius in batch SSP process operating under vacuum or continuous SSP process operating under nitrogen purge. Subsequently final product is cooled and packed.

rBHET is taken in a ratio in the range of 20-100 wt %, amount of diol is in the range of 0-40 wt %, amount of catalyst in the range of 0.02-0.09 wt % and additives in the range of 0-40 wt %.

The process according to the present invention enables manufacture of co-polyesters of melting point in the range 110 degree celcius to 230 degree celcius for various applications in extrusion, coating and spinning and by replacing MEG with other diols such as DEG, a variety of polyesters and co-polyesters are manufactured. For instance, recycled polybutylene terephthalate (rPBT) and recycled polytrimethylene terephthalate (r PTT) can be prepared by replacing MEG in BHET with 1,4 butanediol & 1,3 propanediol. Optionally these heavier diols can be obtained from a bio source. This enables manufacture of green PBT & green PTT.

The following examples illustrates the various embodiments of the present invention and should not be construed to liming the scope of the present invention.

### EXAMPLES

The following exemplary embodiments are just to illustrate the process for manufacture of Polyesters and co-Polyesters starting from rBHET. These examples are for pilot batch reactor of batch size 10 kg. The reactor is equipped with heating coil, agitator, condenser and vacuum system. At the bottom of reactor there is extrusion dye with cooling trough and granulator. Similarly, there is pilot batch tumble dryer with a vacuum system, heating and cooling system. Both the reactors are equipped with circulating hot heat transfer oil circulating system,

### Example-1

Manufacture of Polyester Using BHET

1. At first, the reactor is charged with 13.50 kg rBHET and heating is started with circulating Heat Transfer Medium temperature set point 120 degree celcius. Above 110 degree celcius rBHET powder will melt. At 110 degree celcius batch temperature, the agitator is started.

2. Required quantity of catalyst is added at 110 degree celcius batch temperature. Antimony trioxide solution in MEG is added so as to get 280 ppm Sb in final product.

3. The product temperature is increased gradually to 240° C. At 220° C. MEG starts distilling.

4. At 240° C. reactor evacuation starts and in 30 minutes the reactor pressure is reduced to 500 mb.

5. After holding batch at temperature 240° C. and 500 mb pressure for 15 min, reactor pressure is further reduced gradually to 0.2 mb in 25 minutes and the batch temperature is gradually increased to 290° C. Polymerization will continue with release of MEG-byproduct. The increase in degree of polymerization is evident with increase in power requirement of agitator motor current. At required I.V. the polymerization reaction is terminated and polymer is granulated in chips/granules.

The Granules had Properties:
I.V.: 0.640 dl/g
Carboxyl End groups: 32 mEQ/Kg
Melting Temperature: 254 degree celcius
DEG: 0.80 wt %
Colour L*: 58%
Colour b*: +1.0.

The above product is suitable for applications in Film and textile (PFY/PSF) For applications in BCF, the I.V. is increased to >1.0 by upgrading amorphous chips in Solid state Polymerization (SSP)

### Example-2

### Manufacture of Polyester/Co-Polyester Using BHET

1. The reactor is charged with 11.50 kg rBHET and heating starts with circulating Heat Transfer Medium temperature set point 120 degree celcius. Above 110 degree celcius rBHET will melt. At 110 degree Celsius batch temperature, the agitator is started.

2. Required quantity of catalyst is added at 110 degree celcius batch temperature. Antimony trioxide solution in MEG is added so as to get 280 ppm Sb in final product. 2.0 kg of Bis hydroxy ethylene isophthalate (BHEI) is added to the reactor. The BHEI is prepared by reacting Isophthalic Acid (IPA) with MEG at 240 degree celcius. Also about 0.50% DEG is added to the reactor.

3. The product temperature is increased gradually to 240 degree celcius. At 220 degree celcius MEG will start distilling.

4. At 240 degree celcius reactor evacuation is started. In 30 minutes the reactor pressure is reduced to 500 mb.

5. After holding batch at temperature 240 degree celcius and 500 mb pressure for 15 min, reactor pressure is further reduced gradually to 0.2 mb in 25 minutes and the batch temperature is gradually increased to 290 degree celcius. Polymerization will continue with release of MEG byproduct. The increase in degree of polymerization is evident with increase in power requirement of agitator motor current. At required I.V. the polymerization reaction is terminated & polymer is granulated in chips/granules.

The Properties of Amorphous Granules:
I.V.: 0.600 dl/g
Carboxyl End groups: 35 mEQ/Kg
Melting Temperature: 247 degree celcius
DEG: 1.20 wt %
Colour L*: 58%
Colour b*; −2.0
The amorphous granules are then upgraded in Solid state Polymerization to required I.V. >0.80 for applications in rigid packaging. The properties of SSP granules:
I.V.: 0.80
Carboxyl end groups: 25
DEG: 1.20 wt %
IPA: 1.90 wt %
Colour L*: 78.0%
Colour b*: 0.0

### Example-3

Manufacture of Sulfonated Co-Polyester Using BHET

1) The reactor is charged with 0.950 kg rBHET & heating is started with circulating Heat Transfer Medium temperature set point 120 degree celcius. Above 110 degree celcius rBHET will melt. At 110 degree celcius batch temperature the agitator is started.

2) Required quantity of catalyst is added at 110 degree celcius batch temperature. Antimony trioxide solution in MEG is added so as to get 280 ppm Sb in final product. Also 10 ppm Ti catalyst is added for which TiBT (iso butyl titanate) or TiPT(isopropyl titanate) can be used.

3) 3.0 kg DMSIP (1,5 Dimethyl sulfo isophthalate) is separately reacted with 1,4 butanediol in proportion 1:6 mole ratio in presence of calcium acetate (1.0 wt %) at 250 degree celcius and the resultant ester solution is added to the reactor.

4) Also 800 ppm Pentaerytritol & 300 ppm Pyromellitic dianhydride is added to the reactor.

5) The product temperature is increased gradually to 240 degree celcius. At 220 degree celcius MEG will start distilling.

6) At 240 degree celcius product temperature, 4 kg 1,4 butanediol & 2 kg PEG (Poly Ehtylene Glycol) are added and reactor is pressurized to 2.5 kg/cm2 pressure) Hold batch for 20 minutes under these conditions & then depressurize.

7) Then reactor evacuation is started. In 30 minutes the reactor pressure is reduced to 500 mb.

8) After holding batch at temperature 240 degree celcius & 500 mb pressure for 15 min, reactor pressure is further reduced gradually to 0.2 mb in 25 minutes & the batch temperature is gradually increased to 290 degree celcius. Polymerization will continue with release of MEG-byproduct. The increase in degree of polymerization is evident with increase in power requirement of agitator motor current. At required I.V. the polymerization reaction is terminated & polymer is granulated in chips/granules.

The Granules had Properties:
I.V.: 0.280 dl/g
Carboxyl End groups: 32 mEQ/Kg
Melting Temperature: 220 degree celcius

DEG: 2.5 wt %
Colour L*: 58%
Colour b*: +1.0.

S content: 30000 ppm.

The amorphous granules are then crystallized & upgraded in batch SSP reactor under 0.20 mb pressure at temperature 210 degree celcius to I.V 0.340.

The resultant sulfonated Polyester is used as a masterbatch to impart stain resistance to nylons & cationic dyeabilty to polyesters, PP, PE & Nylons.

### Example-4

Manufacture of rPBT Using rBHET

1. The reactor is charged with 13.50 kg rBHET and heating is started with circulating Heat Transfer Medium temperature set point 120 degree celcius. Above 110 degree celcius rBHET will melt. At 110 degree celcius batch temperature the agitator is started.

2. Required quantity of catalyst is added at 110 degree celcius batch temperature. 150 ppm Ti catalyst in the form of TiBT or TiPT and 4 Kg 1,4 butanediol is added to the reactor.

3. The product temperature is increased gradually to 240 degree celcius. At 190 degree celcius MEG will start distilling.

4. At 240 degree celcius reactor evacuation is started. In 30 minutes the reactor pressure is reduced to 500 mb.

5. After holding batch at temperature 240 degree celcius and 500 mb pressure for 15 min, reactor pressure is further reduced gradually to 0.2 mb in 25 minutes & the batch temperature is gradually increased to 260 degree celcius. Polymerization will continue with release of MEG byproduct. Each MEG molecule in BHET is replaced by butanediol. The increase in degree of polymerization is evident with increase in power requirement of agitator motor current. At required I.V. the polymerization reaction is terminated & polymer is granulated in chips/granules.

The Granules had Properties:
I.V.: 0.820 dl/g
Carboxyl End groups: 32 mEQ/Kg

Melting Temperature: 228 degree celcius
Colour L*:>58%
Colour b*: +1.0.

The above rPBT is suitable for applications in extrusion & injection molding.

### Example-5

Manufacture of rPTT Using BHET

1. The reactor is charged with 13.50 kg rBHET & heating is started with circulating Heat Transfer Medium temperature set point 120 degree celcius. Above 110 degree celcius rBHET will melt. At 110 degree celcius batch temperature the agitator is started.

2. Required quantity of catalyst is added at 110 degree celcius batch temperature. 150 ppm Ti catalyst is used in the form TiBT or TiPT, 3.8 Kg 1,3 Propanediol is added to the reactor.

3. The product temperature is increased gradually to 240 degree celcius. At 220 degree celcius MEG will start distilling.

4. At 240 degree celcius reactor evacuation is started. In 30 minutes the reactor pressure is reduced to 500 mb.

5. After holding batch at temperature 240 degree celcius & 500 mb pressure for 15 min, reactor pressure is further reduced gradually to 0.2 mb in 25 minutes & the batch temperature is gradually increased to 290 degree celcius. Polymerization will continue with release of MEG-byproduct. Each molecule of MEG in BHET is replaced with propanediol. The increase in degree of polymerization is evident with increase in power requirement of agitator motor current. At required I.V. the polymerization reaction is terminated & polymer is granulated in chips/granules.

The Granules had Properties:
I.V.: 0.920 dl/g
Carboxyl End groups: 32 mEQ/Kg

Melting Temperature: 225 degree celcius
Colour L*: >58%
Colour b*: +1.0.

6. The amorphous granules are crystallized & upgraded in SSP process to I.V. level of 1.1 at a temperature of 200 degree celcius under vacuum of <2 mb.

The above rPTT is suitable for applications in spinning of filament yarn, BCF & molding applications

### Example-6

Manufacture of Low Melt Polyesters from rBHET

1. The reactor is charged with 13.50 kg rBHET & heating is started with circulating Heat Transfer Medium temperature set point 120 degree celcius. Above 110 degree celcius rBHET will melt. At 110 degree celcius batch temperature the agitator is started.

2. Required quantity of catalyst is added at 110 degree celcius batch temperature. Antimony trioxide solution in MEG is added so as to get 280 ppm Sb in final product.

3. 4 kg DEG is added to the reactor.

4. The product temperature is increased gradually to 220 degree celcius. At 220 degree celcius MEG will start distilling.

5. At 240 degree celcius reactor evacuation is started. In 30 minutes the reactor pressure is reduced to 500 mb.

6. After holding batch at temperature 240 degree celcius & 500 mb pressure for 15 min, reactor pressure is further reduced gradually to 0.2 mb in 25 minutes & the batch temperature is gradually increased to 290 degree celcius. Polymerization will continue with release of

MEG-byproduct. The increase in degree of polymerization is evident with increase in power requirement of agitator motor current. At required I.V. the polymerization reaction is terminated & polymer is granulated in chips/granules.

The Granules had Properties:
I.V.: 0.640 dl/g
Carboxyl End groups: 32 mEQ/Kg

Melting Temperature: 140 degree celcius
Colour L*: 58%
Colour b*: +1.0.

The above product is suitable for applications in spinning & coating. The I.V. is adjusted as desired.

### Example-7

Manufacture of Masterbatch for Easy Dyeability in Polyesters, Polypropylene (PP) & Polyethylene (PE)

1. The reactor is charged with 8.5 kg rBHET & heating is started with circulating Heat Transfer Medium temperature set point 120 degree celcius. Above 110 degree celcius rBHET will melt. At 110 degree celcius batch temperature the agitator is started.

2. Required quantity of catalyst is added at 110 degree celcius batch temperature. Antimony trioxide solution in MEG is added so as to get 280 ppm Sb in final product.

3 0.2 Kg DMSIP is reacted with 1,4 butanediol & resultant ester solution is added to the reactor along with 1 kg DEG. Also 800 ppm pentaerythritol & 500 ppm Pyromellitic di anhydride are added to the reactor.

4. The product temperature is increased gradually to 240 degree celcius. At 220 degree celcius MEG will start distilling.

5. At 240 degree celcius reactor evacuation is started. In 30 minutes the reactor pressure is reduced to 500 mb.

6. Then the reactor is depressurized & 4 kg PEG (Polyethylene Glycol, molecular weight 400) are added to the reactor.

7. After holding batch at temperature 240 degree celcius & 500 mb pressure for 15 min, reactor pressure is further reduced gradually to 0.2 mb in 25 minutes & the batch temperature is gradually increased to 290 degree celcius. Polymerization will continue with release of MEG-byproduct. The increase in degree of polymerization is evident with increase in power requirement of agitator motor current. At required I.V. the polymerization reaction is terminated & polymer is granulated in chips/granules.

The Granules had Properties:
I.V.: 0.880 dl/g
Carboxyl End groups: 32 mEQ/Kg
Colour L*: 58%
Colour b*: +1.0.

The resultant amorphous granules are upgraded in SSP to I.V. of 1.60 dl/g

The above product is suitable for applications in textiles by blending in proportion upto 12 wt % to impart easy dyeability in Polyesters, PP & PE.

### Example-8

Manufacture of Polyester Using BHET

1. At first, the reactor is charged with 10 kg rBHET and heating is started with circulating Heat Transfer Medium temperature set point 120 degree celcius. Above 110 degree celcius rBHET powder will melt. At 110 degree celcius batch temperature, the agitator is started.

2. Required quantity of catalyst is added at 110 degree celcius batch temperature. Antimony trioxide solution in MEG is added so as to get 280 ppm Sb in final product.

3. The product temperature is increased gradually to 240° C. At 220° C. MEG starts distilling. Add 3.3 kg Ukanol FR (hydroxyphenylphosphinyl propanoic acid”) Additive is added. The batch is held under nitrogen pressure of 3.0 bar for 30 min. Then depressurized.

4. At 240° C. reactor evacuation starts and in 30 minutes the reactor pressure is reduced to 500 mb.

5. After holding batch at temperature 240° C. and 500 mb pressure for 15 min, reactor pressure is further reduced gradually to 0.2 mb in 25 minutes and the batch temperature is gradually increased to 290° C. Polymerization will continue with release of MEG-byproduct. The increase in degree of polymerization is evident with increase in power requirement of agitator motor current. At required I.V. the polymerization reaction is terminated and polymer is granulated in chips/granules.

The Granules had Properties:
I.V.: 0.640 dl/g
Carboxyl End groups: 32 mEQ/Kg
Melting Temperature: 254 degree celcius
DEG: 0.80 wt %
Colour L*: 55%

b*: +2.0

P content: 18000 ppm

The above product is suitable for applications in Film and textile (PFY/PSF)

### Advantages of the Invention

The advantages of above processes are that the product chemically recycled PET made by using recycled BHET is absolutely free of contamination and hence can be used to 100% extent for manufacture of specialty products without any processing issues which will be as good as products made from virgin raw materials such as PTA & MEG/other diols, specifically for applications in textiles & packaging. Secondly, the products are Green and support environment protection & sustainability.

As recycled BHET has very low acid end groups and no esterification reaction to be carried out, therefore, it is possible to make high quality chemically recycled PET as compared to virgin raw material process and the conversion cost is lower than conventional process with virgin raw materials.

As recycled BHET is also free of antimony (Sb) catalyst, final products which are free from heavy metals can be made or prepared.

As recycled BHET is free from Di Ethylene Glycol (DEG) & Purified Isophthalic acid (IPA), high quality textile PET/CoPET Grades with superior stiffness & tenacity can be manufactured.

The co-polyester and/or co-polyester blend has flame retardancy property, high dye ability and permanent stain resistance. The product of the present invention may be used/melt blended with other polyesters, nylon, polyethylene and polypropylene polymers in textile applications to achieve easier and superior dyeability with cationic & disperse dyes than non-blended polymers. For instance, the copolyesters and/or co-polyester blended with Polyesters and & nylons show flame retardancy property (FR Property). The FR property is permanent due to reacted P molecules and do not reduce due to washing. Also, the co-Polyester manufactured according to the present invention blend with nylons to have permanent stain resistance property.

Polyester is obtained from rBHET wherein 99% MEG of rBHET is partly replaced with aliphatic or aromatic diols selected from 1,4 Butanediol (BDO) or 1,3-Propanediol PDO, Diethylene glycol (DEG), hexanediol, cyclohexanedimethanol, or a mixture thereof to obtain recycled polyesters such as rPBT and rPTT. Green PBT & green PTT are thus prepared by replacing MEG in BHET with 1,4 butanediol & 1,3 propanediol are obtained from biosource or petrosource.

Although the embodiments herein are described with various specific embodiments, it will be obvious for a person skilled in the art to practice the invention with modifications. However, all such modifications are deemed to be within the scope of the invention.

I/We claim:

1. A process for preparation of an eco-friendly specialty Polyesters and Co-Polyesters from recycled Bis 2-HydroxyEthyl Terephthalate (rBHET), comprising the steps of:
I. melting rBHET Powder in a reactor by increasing temperature to 120 degree Celsius;
II. adding catalyst and at least one additive to the melted rBHET powder;
III. increasing temperature of the mixture of step II gradually in a range of 120- to 240° C.;
IV. adding diols and/or comonomers to the mixture of step III and applying a pressure of 2.5 bar absolute to the mixture for a time period in the range 30-40 minutes followed by Depressurizing the reactor in 10 minutes and evacuating the reactor gradually to a pressure of 100 mb in 30 minutes to distill the byproduct;
V. increasing temperature of the product to 290° C. and reducing the reactor pressure to 0.20 mb to obtain polymerized product having degree of polymerization (DP) >50;
VI. terminating the reaction and granulating the polymer;
VII. optionally upgrading the granules by solid state polymerization (SSP) process at a temperature in the range of 160 to 220° C. under vacuum in batch reactor or in continuous SSP process operating under nitrogen purge;
VIII. cooling and packing the polyester or co-polyester obtained as the final product.

2. The process as claimed in claim 1, wherein the rBHET is taken in a ratio in the range 20-100 wt %, amount of diol is in the range of 0-40 wt %, amount of catalyst in the range of 0.02-0.09 wt % and additives in the range of 0-40 wt %.

3. The process as claimed in claim 1, wherein the diols are aliphatic or aromatic diols are selected from the group consisting of mono ethylene glycol (MEG), Diethylene glycol (DEG), 1,3-Prapanediol, 1,4-butanediol, hexanediol and cyclohexanedimethanol.

4. The process as claimed in claim 1, wherein the comonomers are selected from the group of aliphatic and aromatic diacids selected from dicarboxylic acids acids/esters of succinic acid, adipic acid, isophthalic acid, sebacic acid, NDA(Naph-thene dicarboxylic acid), hydroxyphenylphosphinyl propanoic acid IPA, NDC, Naphthoic acid and aromatic diacid.

5. The process as claimed in claim 1, wherein the catalysts are selected from the group of oxides/acetate compounds of the metals including antimony (Sb), Titanium(Ti), Germanium(Ge), Manganese(Mn), Cobalt(Co), Tin(Sn), Ca(Calcium) and are used up to 800 ppm of the element.

6. The process as claimed in claim 4, wherein the metal compound is selected from the group consisting of antimony trioxide, antimony triacetate, Tetra isopropyl titanate, tetra butyl titanate, iso-propyl titanate, Potassium Titanium oxalate and Germanium Dioxide.

7. The process as claimed in claim 1, wherein the additives are selected from catalysts, branching agents/chain extenders, Isosorbides, Polyalkylene glycols, heat stabilizers, antioxidants, nucleating agents, fast crystallizing Polyesters, aliphatic or aromatic dicarboxylic acids or esters and aromatic metal sulfonated salt of 2 weight % to 50 weight % wherein the metal is selected from Li, Na, K, Mg, Ca, Ni or Fe.

8. The process as claimed in claim 7, wherein the additives are selected from the group of:
Isosorbides, Polyalkylene glycols such as Poly Ethylene Glycols (PEG) of molecular weights up to 10000 and Poly Propylene Glycols;
heat stabilizers and antioxidants incorporated in polymerization process up to 8000 ppm;
branching agents/chain extenders added up to 8000 ppm;
nucleating agents added up to 2000 ppm;
fast crystallizing Polyesters such as PBT & PTT are incorporated up to 20 weight %;
aliphatic and aromatic dicarboxyllic acids or esters of these acids such as succinic acid, adipic acid, isophthalic acid, Naphthalene dicarboxylic acid incorporated to the extent 20%; and
aromatic metal sulfonated salt of 2 weight % to 50 weight %.

9. The process as claimed in claim 7, wherein the branching agents/chain extenders are selected from the group of selected from 1,2,4-benzenetricarboxylic acid (trimellitic acid); trimethyl-1,2,4-benzenetricarboxylate; 1,2,4-benzenetricarboxylic anhydride (trimellitic anhydride); 1,3,5-benzenetricarboxylic acid; 1,2,4,5-benzenetetracarboxylic acid (pyromellitic acid); 1,2,4,5-benzenetetracarboxylic dianhydride (pyromellitic anhydride); 3,3′,4,4′-benzophenonetetracarboxylic dianhydride; 1,4,5,8-naphthalenetetracarboxylic dianhydride; citric acid; tetrahydrofuran-2,3,4,5-tetracarboxylic acid; 1,3,5-cyclohexanetricarboxylic acid; pentaerythritol, 2-(hydroxymethyl)-1,3-propanediol; 2,2-bis(hydroxymethyl) propionic acid; sorbitol; glycerol; particularly, branching agents may include pentaerythritol, trimellitic acid, trimellitic anhydride, pyromellitic acid, pyromellitic dianhydride and sorbitol.

10. The process as claimed in claim 7, wherein polyalkylene glycols may be selected from glycols such as Poly Ethylene Glycols (PEG) of molecular weights up to 10000 and Poly Propylene Glycols; Fast crystallizing Polyesters and the heat stabilizers are selected from flame retardants such as decabromodiphenyl ether and triarylphosphates, such as triphenylphosphate.

11. The process as claimed in claim 7, wherein the aromatic metal sulfonated salts are selected from SIPA/DMSIP (Dimethyl-5-Sulfoisophthalate Sodium Salt) or the Esters thereof.

12. The process as claimed in claim 7, wherein the fast crystallizing Polyesters are selected from the group of polybutylene terephthalate (PBT), polypropylene terephthalate (PTT), polybutylene naphthalate (PBN), fast crystallizing polyester and, polypropylene naphthalate (PTN).

13. The process as claimed in claim 7, wherein the nucleating agents consisting of carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, potassium dibenzoate, lithium dibenzoate, sodium β-naphthalate and sodium cyclohexane carboxylate; organic sulfonates such as sodium p-toluene sulfonate and sodium sulfoisophthalate; carboxylic acid amides such as stearic acid amide, ethylene bis-lauric acid amide, palmitic acid amide, hydroxystearic acid amide, erucic acid amide and tris(t-butylamide) trimesate; phosphoric compound metal salts such as benzylidene sorbitol and derivatives thereof, sodium-2,2′-methylenebis(4,6-di-t-butylphenyl)phosphate, and 2,2-methylbis(4,6-di-t-butylphenyl)sodium.

14. polyester/co-polyester obtained from the process as claimed in claim 1, characterized in that:
Melt flow rate of 5 to 60 g/10 min at 270° C. under 2.16 kg weight;
Intrinsic viscosity in the range of 0.250 dl/g to 1.60 dl/g;
Sulfonated salt content up to 50 weight % i.e. Sulfur content upto 50000 ppm;
Phosphorous content up to 60000 ppm as reactive flame retardant additive.

15. The polyester as claimed in claim 1, wherein the polyester is obtained from rBHET wherein 99% MEG of rBHET is partly replaced with aliphatic or aromatic diols selected from 1,4 Butanediol (BDO) or 1,3-Propanediol PDO, Diethylene glycol (DEG), hexanediol, cyclohexanedimethanol, or a mixture thereof to obtain recycled polyesters such as rPBT and rPTT.

16. The polyester as claimed in claim 15, wherein green PBT & green PTT are prepared by replacing MEG in BHET with 1,4 butanediol & 1,3 propanediol obtained from petrosource or Biosource.

17. The polyester as claimed in claim 14, wherein the polyester is a co-polyester or a blended co-polyester.

18. (canceled)

19. (canceled)
